(19) United States
(12) Patent Application Publication
(10) Pub. No.: US 2014/0361558 A1
(43) Pub. Date: Dec. 11, 2014

(54) VARIABLE THICKNESS ROLL FORMED BEAM

(71) Applicant: Shape Corp., Grand Haven, MI (US)

(72) Inventors: Brian Malkowski, Allendale, MI (US); Joe Matecki, Allendale, MI (US)

(73) Assignee: Shape Corp., Grand Haven, MI (US)

(21) Appl. No.: 14/260,437

(22) Filed: Apr. 24, 2014

Related U.S. Application Data
(60) Provisional application No. 61/833,153, filed on Jun. 10, 2013.

(51) Int. Cl. B60R 19/18

(52) U.S. Cl. CPC B60R 19/18
USPC 293/102; 29/897.2

(57) ABSTRACT

A bumper reinforcement beam provides improved bending stiffness and strength, while reducing weight and maintaining functional bending impact strength. The illustrated beam is roll formed and includes a B-shaped cross section with upper and lower tubular sections sharing a common horizontal wall. A first material of the lower tubular section, including the common horizontal wall, is thinner than a second material forming a remainder of the upper tubular section. By using this arrangement for bumper beams that are likely to be impacted above a centerline, beam weight can be reduced by 2.5% to 6.7% or greater; while the stroke (intrusion into the vehicle) of impactors is generally maintained and maximum load capability (beam bending strength) is maintained.

This application claims priority under 35 USC section 119(e) of United States Provisional Patent Application Ser. No. 61/833,153, filed on Jun. 10, 2013, entitled VARIABLE THICKNESS ROLL FORMED BEAM, the entire disclosure which is hereby incorporated by reference in its entirety.

### BACKGROUND

The present invention relates to beams made from varied thickness walls, and more particularly to beams made with varied thickness walls selectively positioned for optimal impact energy management characteristics, including bending and torsion strength attributes.

Bumper beams have been tested using a three-point bend analysis for many years as a way of measuring their bending strength and impact worthiness. However, three-point bend testing and analysis does not reflect many vehicle impacts, nor recent vehicle test standards promoted by the Insurance Institute of Highway Safety (IIHS). For example, the IIHS bumper barrier test protocol often produces an offset from the bumper to the impact test, where the bumper being tested is now subject to bending and torsional loads, due to the offset nature of the test. It is desirable to provide a bumper beam that meets functional requirements, but that also minimizes beam weight by placing material to a location of maximum advantage and by reducing weight in locations of “lesser need”.

### SUMMARY OF THE PRESENT INVENTION

In one aspect of the present invention, a bumper reinforcement beam for a vehicle includes, a B-shaped roll formed beam having upper and lower tubular sections sharing a common horizontal wall, with a first material of one of the upper and lower tubular sections, including the common horizontal wall, being thinner than a second material forming a remainder of the other of the upper and lower tubular sections.

In another aspect of the present invention, a beam includes sheet material roll formed into upper and lower tubular sections, the tubular sections each having walls defining vertical and horizontal planes and sharing a common horizontal wall, where a first material that forms one of the upper and lower tubular sections and that forms the common horizontal wall being thinner than a second material forming a remainder of the other of the upper and lower tubular sections.

In another aspect of the present invention, a method of constructing a bumper reinforcement beam for a vehicle includes providing a sheet of material having a first width of thinner material and a second width of thicker material; roll forming a B-shaped beam having the upper and lower tubular sections sharing a common horizontal wall, with one of the upper and lower tubular sections, including the common horizontal wall, being made of the first width, and a remainder of the other of the upper and lower tubular sections being made of the second width. The B-shaped beam places reduced thickness in selected areas where torsion strength is required (because torsion strength is less dependent on material thickness) and bending strength is less necessary, and also places increased thickness in areas experiencing a bending failure mode, i.e. local buckling of the impact face. The method includes attaching the B-shaped beam to a vehicle as part of a bumper assembly.

An object of the present invention is to minimize beam weight while maintaining or improving functional impact characteristics.

An object of the present invention is to provide a mono-leg bumper beam having an improved bending characteristic where required on the section, while maintaining or nearly maintaining the torsion strength of the entire bumper beam section.

An object of the present invention is to provide a B-shaped beam having a bottom lobe that preserves torsion loading capacity, while having a slightly thicker walled top lobe that increases stability and prevents buckling and prevents parallel-o-gram type collapse upon impact.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are perspective and side schematic views' showing a simulation of a test cart impacting the IIHS bumper barrier (22+23), the impactor hits the bumper beam above a center of the beam, thus creating unbalanced stresses associated with the unequally distributed bending loads on the bumper beam.

FIGS. 3-5 are side views of three different bumper beams having identical cross sections, the first beam (FIG. 3) being made of a constant thickness wall material, the second beam (FIG. 4) having an upper tubular section completely of a thicker wall material, and the third beam (FIG. 5) having an upper tubular section made in part of a thicker wall material but the common center wall being made of a thinner wall material.

FIG. 6 is a chart giving results of testing various beams, including beams with varied wall thickness and resulting weight and functional characteristics.

FIG. 7 is a graph illustrating force-deflection impact curves for a baseline beam and the innovative beam of FIG. 5.

FIG. 8 is a graph illustrating back-of-beam deflection due to an impact stroke for the baseline beam and the innovative beam of FIG. 5.

FIGS. 9-10 are cross sections of modified beams formed by separated roll formed beams welded together, where the two beams are each made using different thickness materials, FIG. 9 showing an open-channel beam welded to a tubular beam, FIG. 10 showing two tubular beams welded together.

FIG. 11 is a cross section of another modified bumper beam formed by a sheet having two different thickness materials, but where the upper and lower tubular sections are spaced apart.

### DETAILED DESCRIPTION OF PREFERRED EMBODIMENTS

Vehicle bumper systems are often tested using a vehicle-simulating sled 20 (which attempts to match several vehicle attributes such as mass, mass distribution, and suspension characteristics) with a bumper beam 21 mounted to its front. The sled 20 can be run into the bumper barrier impactor 22 having a bumper-simulating face 23 for impacting the beam 21. The test is carried out according to a bumper test protocol promoted by the Insurance Institute of Highway Safety (IIHS). The impact protocol places the bottom of the impactor at a height of 18″ and is 4″ tall, making it generally cover a vertical beam width of 18-22 inches from the ground. Other regulatory impacts from NHTSA include test protocols which would benefit from having the beam be between 16-20″ from the ground. These two impacts are seemingly at conflict for where they place the beam in a vertical direction. The beam is very often placed in the preferred zone for regulatory impacts, 16-20″. This placement often produces scenarios in which the bumper barrier impactor face 23 impacts the beam 21 at an offset location above a centerline of the beam 21. This results in considerable torsional forces imparted to the beam, as well as significant bending forces which tend to be imparted more on the portion of the beam which overlaps the bumper barrier face. It is noted that the functional requirements and stress distribution of bumper beams during an impact are unusual, given its need to absorb high amounts of torsional energy and bending energy from the impact while being supported only at its outer ends by vehicle frame rails.

A bumper reinforcement beam 50 (FIG. 5) embodying the present invention is designed for mounting to frame rail tips of a particular vehicle frame. The beam 50 provides high bending stiffness and strength, while reducing weight (mass) and improving (or maintaining) functional impact strength when compared to a beam made from a single sheet of material having a constant thickness and constant material properties. The illustrated innovative beam 50 is roll formed and includes a B-shaped cross section with upper and lower tubular sections 51, 52 sharing a common horizontal wall 53. The upper tubular section 51 includes top, front, and rear walls of a first thickness material (e.g. 190 ksi, 1.3 mm thickness), and the lower tubular section 52 includes top, front, rear, and bottom walls of a second thickness material (e.g. 190 ksi, 1.0 mm thickness). All walls are generally planar, but a channel rib 54 is formed in the front wall of section 51, and a channel rib 55 is formed in the front wall of section 52. A size and shape of the tubular sections 51,52 and of the channel ribs 54,55 can be varied, depending on functional requirements of a particular beam. The illustrated beam 50 has a cross section of 120 mm high by 40 mm deep, with both tubular sections 51 and 52 being about the same size, and with the channel ribs 54,55 being about 20%-40% (or more preferably about 30%-35%) of a height of their respective front walls and extending into the respective tubular section by about 20%-25%.

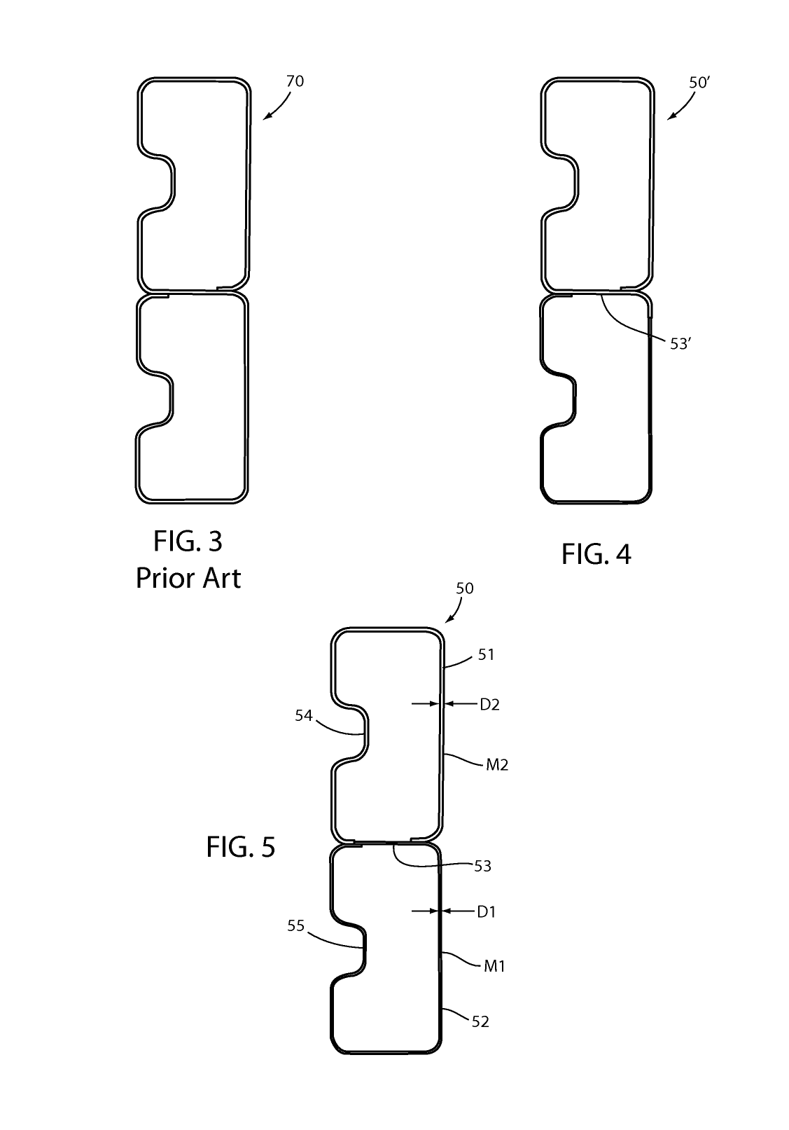

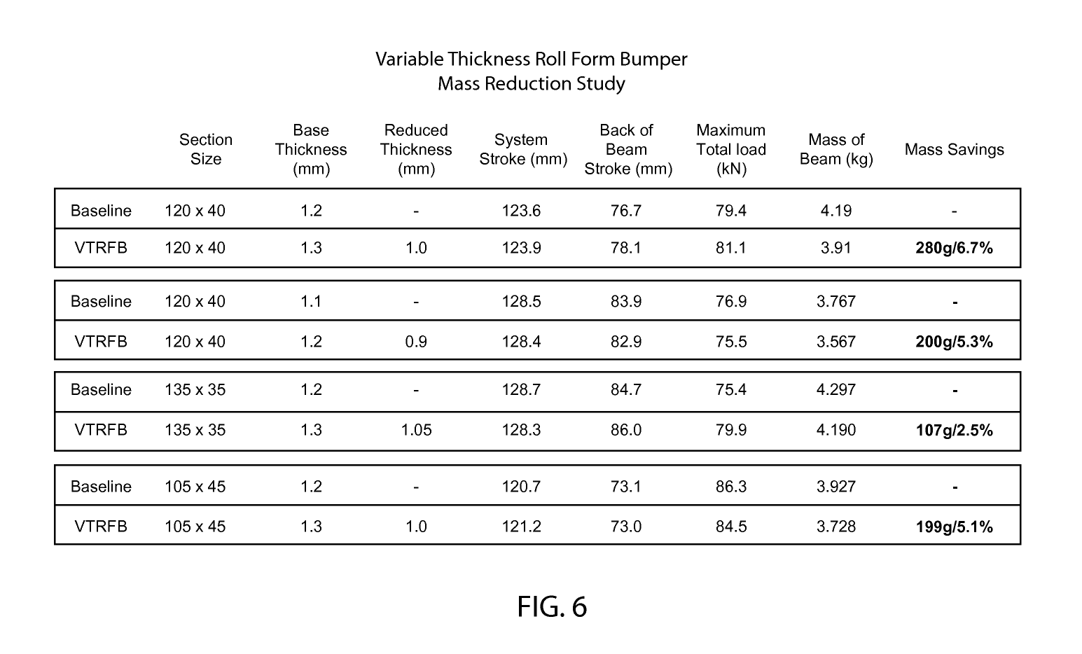

Beam 70 (FIG. 3) illustrates prior art. It is similar in size and shape to beam 50, but beam 70 is made from a single sheet of material having a constant thickness and constant material properties. For example, see the first/top horizontal row of data shown in the chart of FIG. 6, which is referred to as “baseline” data.

Beam 50′ (FIG. 4) is similar to beam 50, except in beam 50′, the common wall 53′ is formed by the thicker material of the upper tubular section 51′. Beam 50′ illustrates a modified beam embodying aspects of the present innovation.

Roll forming technology is generally known in the art and hence a detailed description of roll forming technology and processes is not necessary for a person skilled in this art upon reviewing the present disclosure and drawings. In the present beam 50 (FIG. 5), a first material M1 of the lower tubular section 51, including the common horizontal wall 53, is thinner (i.e. has a reduced thickness dimension D1) than a thicker second material M2 forming a remainder of the upper tubular section 52. For example, the materials M1 and M2 can be the same, such as a M190 material, which is a very high strength steel alloy. Our testing shows that by using this arrangement for bumper beams that are likely to be impacted above a centerline, beam weight can be reduced by 2.5% to 6.7% (or greater), while beam stroke (such as back-of-beam intrusion into the vehicle) is maintained and maximum load capability (beam bending strength) is maintained. See FIG. 6, which includes four double-rows of data comparing beams made similar to beam 70 (FIG. 3) to beams made similar to beam 50 (FIG. 5).

Specifically, each of the four double-rows of data in FIG. 6 includes a first row of data from testing a baseline beam (50) roll formed from a single sheet of material having a constant thickness and constant material properties, and compares it to a second row of data from testing a variable thickness roll formed bumper beam 50 (hereafter called a VTRFB beam) made according to FIG. 5.

In the present innovative beam 50 (FIG. 5), two different thickness of coil sheet steel are welded together to form a single coil, one width portion (M1) being thinner and slightly wider, and one width portion (M2) being thicker (creating a condition sometimes referred to herein as a “variable thickness” sheet). In the illustrated beam 50 in FIG. 5 (a preferred beam), the thicker material M2 only has sufficient width to make three walls of the upper tubular section 51, and the thinner material M1 has sufficient width to make the four walls of the lower tubular section 52, with the thinner material also making the common center horizontal wall 53. This way, the thickness in the bumper is more optimally distributed where it is needed, and excess steel (i.e. the “excess steel” from the increased thickness) is kept away from a location on the beam where it is not needed (i.e. where it would be “wasted”).

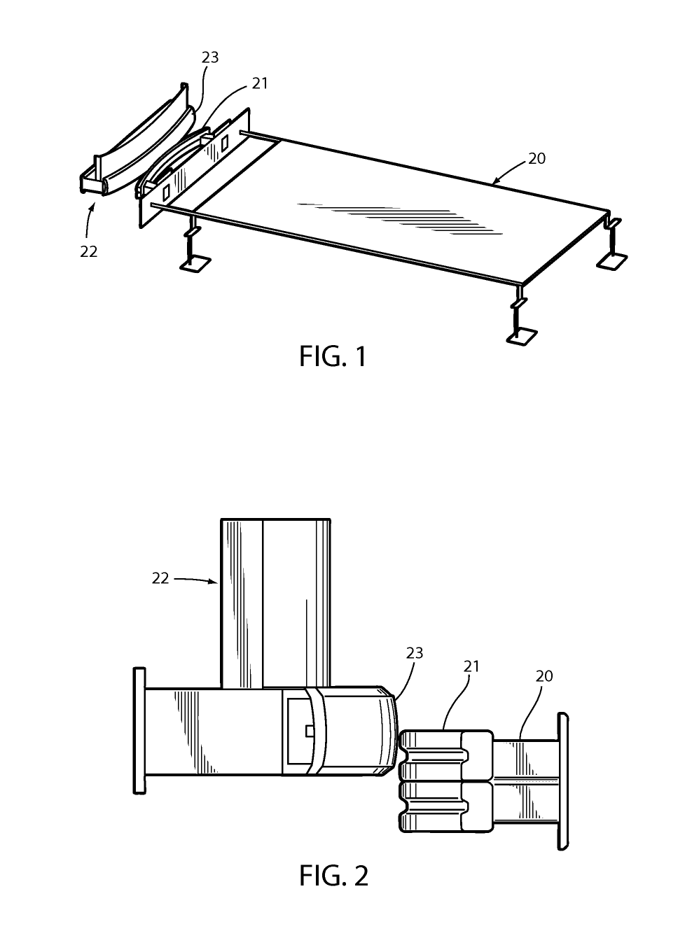

The illustrated beam 50 (FIG. 5) illustrates the walls of the upper tubular section 51 (i.e. not including the common center wall) as having a greater thickness, and the walls of the lower tubular section 52 (including the common wall 53) as being thinner. This arrangement is most effective for bumper beams where an expected impact is relatively above a centerline of the beam (see FIGS. 1-2). However, it is contemplated to be within a scope of the present innovation that the tubular sections can be inverted and used in a vehicle where it is functionally desirable for the lower tubular section to withstand a primary (offset) impact. Also, it is contemplated that additional variations in wall thickness may be desirable. See FIG. 4 which shows a modified beam 50′ where the common horizontal center wall 53′ is made of the thicker sheet material. Also, it is noted that a lesser quality, lower cost, or lower strength material could potentially be used to make the common wall 53′ and lower tube, thereby saving cost.

It is contemplated that the beams having various section sizes can incorporate the present technology. For example, it is contemplated that vehicle bumper beams could have tubular cross sections that are in the range of about 90-140 mm high and 30-60 mm wide (in a fore-aft direction when in a vehicle-mounted position), with top and bottom tubular sections having a shape and configuration not unlike that shown in FIGS. 4-5.

Regarding the material of the beams, the present innovation is particularly effective for thinner sheets of high strength steels, which occurs as hardness and tensile strengths are increased in order to reduce material and save weight. Notably, ultra high strength materials are sometimes used in order to reduce weight, but walls made of very thin materials often become unstable and fail prematurely and unpredictably upon impact. In the present case, the illustrated beam (FIG. 5) is made of martensite steels of 190 KSI or above, or can also be made of dual phase steel such as 90-175 KSI tensile strength (600 MPa-1200 MPa tensile strength). For the top portion of the beam that overlaps/abuts the impact barrier tester, the thicknesses will be higher than lower parts of the beam, such as by 0.1-0.4 mm higher for the upper tubular section 51. However, it is contemplated that a scope of the present invention also includes tensile strength steels of 80-120 ksi, and potentially includes materials other than steel, including aluminum, alloys, reinforced materials, and the like.

Part of the logic of the present innovation is that the IIHS (Insurance Institute for Highway Safety) has a bumper barrier impactor that tends to be offset from the bumper beams on a vehicle. This puts the beam into a “combined loading” scenario of bending and torsion. Bending strength is dominated by thickness, material yield strength, and plastic section modulus. However, torsion strength is dominated by enclosed area more that thickness of material or material strength. The material factor that plays a part in torsion strength is constant across all steel grades. Since the IIHS bumper barrier is offset to the bumper beam, the top of the beam is seeing more bending behavior, and the bottom is “along for the ride” and more or less “merely” contributing to the torsion strength of the section. This theoretically explains why the distributed thickness to the top area makes sense, since it needs the thickness to resist the bending. Contrastingly, the bottom can go thinner because it's main job is to close the section to add to the overall torsion strength of the section.

It is contemplated that the common horizontal center wall may include a lower quality material or thinner material while still satisfying its intended function of stabilizing tubular sections, maintaining bending strength, and maintaining stability of other walls contributing to torsional strength. This is because of the dynamics during an impact, where the common center wall undergoes different stresses than the walls forming an outer perimeter of the beam 50, especially during torsional loading.

Several beams were made like FIG. 5 (i.e. having a top tubular section with thicker walls and having a bottom tubular section with thinner walls, where the common center wall was the thinner wall material, but both materials for top and bottom tubes were made of 190 KSI material). These were tested against the baseline beam 70 of FIG. 3 (i.e. having a constant wall thickness and constant material properties throughout the beam 70). For example, the first two lines in the chart of FIG. 6 shows a baseline beam 70 (i.e. the constant-wall-thickness beam) having a sheet thickness of 1.2 mm and having a cross sectional forming top and bottom tubular sections with total size of 120 mm (total height) and 40 mm (fore-aft direction). The comparable beam of the present innovation had similar total size of 120 mm and 40 mm, but had a first sheet thickness (i.e. wall thickness) of 1.3 mm for the top tubular section (including the common center wall) and a second sheet thickness of 1.0 mm for the bottom tubular section (excluding the common center wall). Both the top and bottom tubular sections were a same size, and both included a front channel rib, as described above in beam 50. The system stroke upon impact (i.e. the impact stroke or intrusion into the vehicle) was 123 mm for both, and the back-of-beam stroke upon impact (i.e. the movement of the back surface of the beam) was also very similar. Specifically, the beam stroke upon impact for the constant-wall-thickness beam was 76.7 mm, and for the variable-wall-thickness beam was 78.1 mm. The maximum total impact load for the constant-wall-thickness beam was 79.4 kN, and the variable-wall-thickness beam was 81.1 kN. However, a weight of the constant-wall-thickness beam was 4.19 kg, while a weight of the variable-wall-thickness beam was 3.91 kg. This is a weight (mass) savings of 280 grams, or 6.7%, even though the performance was about the same.

Several additional beams were tested using a same general cross sectional shape, and similar results were obtained for each. For example, see the second two rows of data in FIG. 6, where both the baseline beam and the innovative beam have upper and lower tubular section sizes of 120 mm×40 mm, but the wall thickness of the constant-wall-thickness beam is 1.1 mm, while the wall thickness of the innovative variable-wall-thickness beam is 1.2 mm for the upper tubular section (excluding the common center wall) and is 0.9 mm for the lower tubular section (including the common center wall). Notably, this results in a 200 gram weight savings (i.e. 5.3%).

Also, see the third two rows of data in FIG. 6, where both beams have upper and lower tubular section sizes of 135 mm×35 mm, but the wall thickness of the constant-wall-thickness beam is 1.2 mm, while the wall thickness of the innovative variable-wall-thickness beam is 1.35 mm for the upper tubular section (including the common center wall) and is 1.05 mm for the lower tubular section (excluding the common center wall). Notably, this results in a 107 gram weight savings (i.e. 2.5%).

Also, see the fourth two rows of data in FIG. 6, where both beams have upper and lower tubular section sizes of 105 mm×45 mm, but the wall thickness of the constant-wall-thickness beam is 1.2 mm, while the wall thickness of the innovative variable-wall-thickness beam is 1.3 mm for the upper tubular section (including the common center wall) and is 1.0 mm for the lower tubular section (excluding the common center wall). Notably, this results in a 199 gram weight savings (i.e. 5.1%).

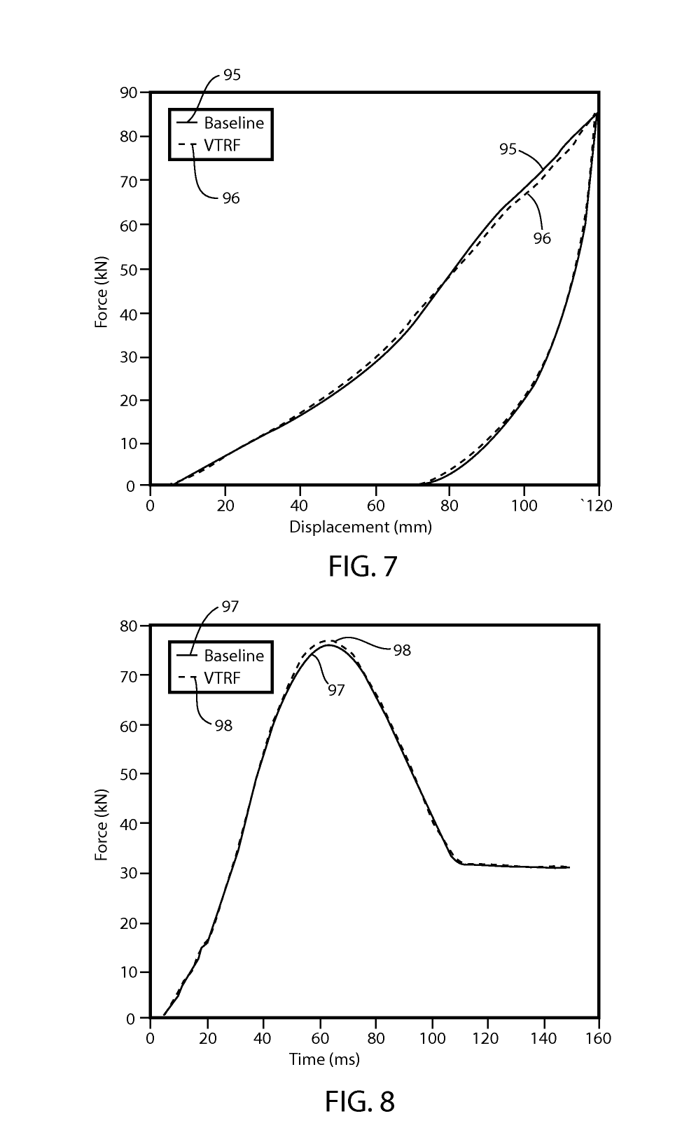

FIG. 7 is a graph illustrating force-deflection impact curves for a baseline beam (i.e. a single thickness wall) and the innovative beam of similar shape to that shown in FIG. 5. The baseline beam 70 is a material M190, thickness of sheet is 1.30 mm, and mass of 4.32 kg; while the innovative VTRFB beam 50 is made of two sheet materials, both materials being M190, one being a thickness of 1.36 mm and the other being a thickness of 1.0 mm, which results in total mass of 3.90 kg. In FIG. 7, the line 95 is for the force-deflection of the baseline beam 70, and the line 96 is for the force-deflection of the innovative VTRFB beam 50. FIG. 8 is a graph illustrating back-of-beam deflection due to an impact stroke for the baseline beam and the innovative VTRFB beam 50 described in this paragraph above. The line 97 represents the back-of-beam deflection for the baseline beam 70, and the line 98 represents the back-of-beam deflection for the innovative VTRFB beam 50.

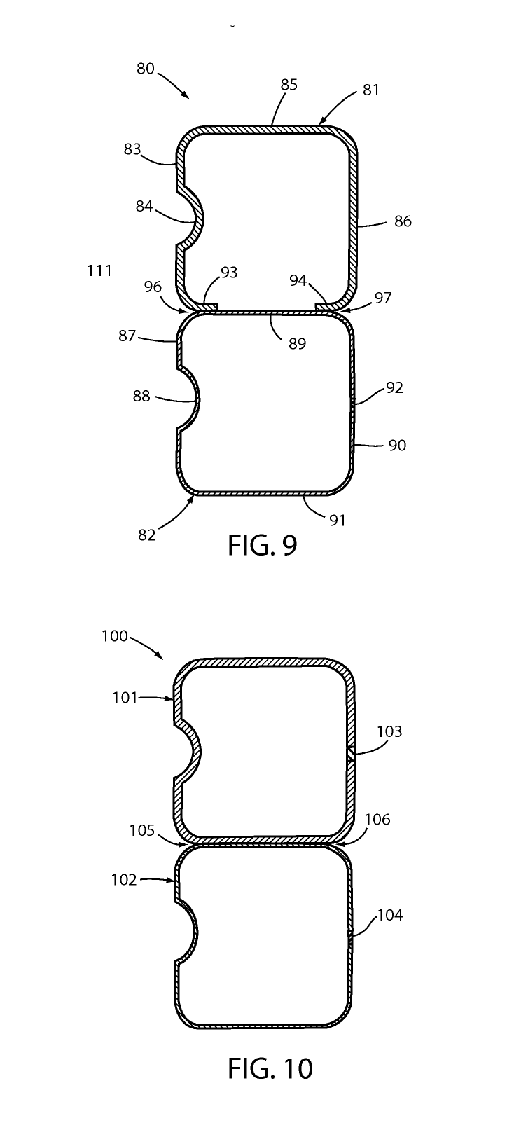

FIGS. 9-10 are cross sections of modified beams formed by separated roll formed beams welded together, where the two beams are made using different thickness sheet materials and/or different hardness materials. In particular, FIG. 9 shows a combination double-tube beam 80 formed by a separately-roll-formed downwardly-open-channel top beam 81 welded at front and rear locations to a separately-roll-formed tubular bottom beam 82. It is contemplated that the welding can be done in a secondary welding operation remote from the location where the beams 81 and 82 are roll formed. Alternatively, it is contemplated that one of the beams (e.g. top beam 81) can be roll formed and cut to length, and then positioned on and welded to the other beam (e.g. bottom beam 82) as the “other” beam is coming out of its roll forming apparatus.

Notably, the illustrated top beam 81 includes a front wall 83 with channel-rib 84, top wall 85 and rear wall 86. The bottom beam 82 includes a front wall 87 with channel-rib 88, top wall 89, rear wall 90, and top wall 91, welded at location 92. The front wall 83 and rear wall 86 of top beam 81 include inwardly-extending flanges 93 and 94 that extend sufficiently to provide reliable abutting contact with the top wall 89 of the bottom beam 82. The front flange 93 forms with adjacent front portions of the top wall 89 an inwardly-extending front crevice 96 that can be welded by a laser welder or by other welding means know in the art. The rear flange 94 forms a similar rear crevice 97 that is welded to adjacent rear portions of the top wall 89. It is noted that the inward orientation of the flange 94 (hereafter called a “crevice-forming flange”) is preferred over a flange that extends parallel the rear wall 86 into overlapping abutting contact with an outer surface of the rear wall 90 (hereafter called the “outer-surface-abutting flange”) because the crevice-forming flange 94 has tested to provide better impact results (e.g. a lower tendency to kink and prematurely fail). The same can be said for flange 93.

FIG. 10 is similar to FIG. 9, except FIG. 10 shows a double-tube beam 100 formed by two separately-roll-formed tubular beams 101 and 102. The beams 101 and 102 are welded into permanent tubular sections at weld locations 103 and 104, and are welded together at front weld location 105 and rear weld location 106. The beams 101 and 102 are each tubular and as illustrated have a similar size and shape, but it is contemplated that the beams 101 and 102 can be made from different materials with different thicknesses and/or different physical properties or chemistries, and can be made to have different shapes. As illustrated, the two beams 101 and 102 have abutting planar walls that create front and rear crevices, not unlike crevices formed by flanges 93 and 94 discussed above. The interconnecting welds 105 and 106 can be continuous (e.g. laser welding or MIG), or can be spot welded at desired locations along their lengths.

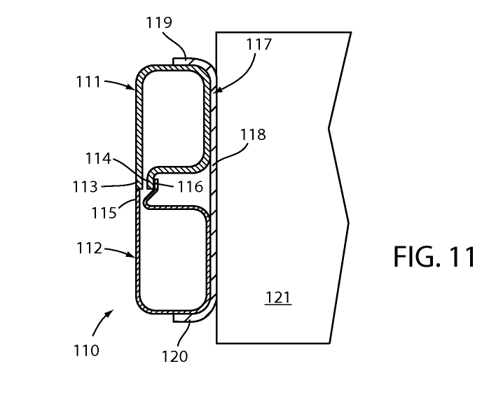

FIG. 11 is a cross section of another modified bumper beam 110 formed by a sheet having two different thickness materials (i.e. like beam 50), but where the upper and lower tubular sections 111 and 112 are spaced apart by intermediate wall flanges 113/114 and 115/116. The upper tubular section 111 includes top, bottom, front and rear walls of thicker material, and the bottom tubular section 112 includes top, bottom, front and rear walls of thinner material. The intermediate wall flanges 113/114 extend from the top tubular section 111 and include thicker material, and the intermediate wall flanges 115/116 extend from the bottom tubular section 112 and include thinner material. A C-shaped mounting bracket 117 includes a base plate 118 and lips 119 and 120 that help contain the tubular sections 111 and 112 together during an impact. The bracket 117 mounts to a vehicle frame rail 121 (or frame rail tip).

It is to be understood that variations and modifications can be made on the aforementioned structure without departing from the concepts of the present invention, and further it is to be understood that such concepts are intended to be covered by the following claims unless these claims by their language expressly state otherwise.

1. A bumper reinforcement beam for a vehicle comprising:
a B-shaped roll formed beam having upper and lower tubular sections sharing a common horizontal wall, with a thinner first material of one of the upper and lower tubular sections, including the common horizontal wall, being thinner than a thicker second material forming a remainder of the other of the upper and lower tubular sections.

2. The beam of claim 1, wherein the lower tubular section includes walls formed by the first material, including the common horizontal wall.

3. The beam of claim 2, wherein the walls of the lower tubular section include top, front, rear and bottom walls, and wherein the upper tubular section includes top, front and rear walls, with the front walls of the upper and lower tubular sections being vertically aligned, and with the rear walls of the upper and lower tubular sections being vertical aligned.

4. The beam of claim 3, wherein at least one of the front walls of the upper and lower tubular sections includes a channel rib.

5. The beam of claim 4, wherein both of the front walls of the upper and lower tubular sections include a channel rib.

6. The beam of claim 5, wherein a cross section of the upper tubular section includes a vertical height dimension that is at least twice a horizontal depth dimension of the cross section.

7. The beam of claim 6, wherein a cross section of the lower tubular section includes a vertical height dimension that is at least twice a horizontal depth dimension of the cross section of the lower tubular section.

8. The beam of claim 1, wherein the first and second materials both have a tensile strength of at least 80 ksi.

9. The beam of claim 8, wherein the first and second materials both have a tensile strength of at least 190 ksi.

10. The beam of claim 9, wherein a thickness of the first material is less than 1.05 mm and a thickness of the second material is greater than 1.2 mm.

11. The beam of claim 1, wherein the front wall of each the upper and lower tubular sections includes a channel rib extending at least about 20% to 40% of a vertical height of the respective front wall of each the upper and lower tubular sections.

12. A beam comprising:
sheet material roll formed into upper and lower tubular sections, the tubular sections each having walls defining vertical and horizontal planes and sharing a common horizontal wall; and
a first material that forms one of the upper and lower tubular sections and that forms the common horizontal wall being thinner than a second material forming a remainder of the other of the upper and lower tubular sections.

13. A method of constructing a bumper reinforcement beam for a vehicle comprising:
providing a sheet of material having a first width of thinner material and a second width of thicker material;
roll forming a B-shaped beam to have upper and lower tubular sections sharing a common horizontal wall, with one of the upper and lower tubular sections, including the common horizontal wall, being made of the first width of thinner material, and a remainder of the other of the upper and lower tubular sections being made of the second width of thicker material, the B-shaped beam having greater bending stiffness and strength when impacted off center against the one tubular section made of the second width of thicker material than a similar beam having a constant thickness sheet material; and
attaching the B-shaped beam to a vehicle as part of a bumper assembly.
